(19) United States
(12) Patent Application Publication
(10) Pub. No.: US 2016/0313255 A1
(43) Pub. Date: Oct. 27, 2016

(54) ELECTRONIC READER

(71) Applicants: PRESIDENT AND FELLOWS OF HARVARD COLLEGE, Cambridge, MA (US); TRUSTEES OF BOSTON UNIVERSITY, Boston, MA (US)

(72) Inventors: Keith PARDEE, Boston, MA (US); James J. COLLINS, Newton, MA (US); Thomas C. FERRANTE, Newton, MA (US)

(73) Assignees: PRESIDENT AND FELLOWS OF HARVARD COLLEGE, Cambridge, MA (US); TRUSTEES OF BOSTON UNIVERSITY, Boston, MA (US)

(21) Appl. No.: 15/102,210

(22) PCT Filed: Dec. 5, 2014
(86) PCT No.: PCT/US14/68824

§ 371 Date: Jun. 6, 2016

Related U.S. Application Data
(60) Provisional application No. 61/913,091, filed on Dec. 6, 2013.

(51) Int. Cl. G01N 21/84; G01N 21/64; G01N 21/78

(52) U.S. Cl. CPC G01N 21/8483; G01N 21/78; G01N 21/6452; G01N 2201/062; G01N 2201/06113

(57) ABSTRACT

The present invention relates to electronic readers configured to perform optical measurements (e.g., absorbance, fluorescence, luminescence, colorimetric analysis, etc.) on samples present on porous matrices. The electronic readers are particularly useful for measuring paper-based devices.

### CROSS-REFERENCE TO RELATED APPLICATION

This application claims benefit under 35 U.S.C. §119(e) of U.S. Provisional Application No. 61/913,091 filed Dec. 6, 2013, the contents of which are incorporated herein by reference in their entirety.

### TECHNICAL FIELD

The present disclosure relates generally to electronic systems for performing optical measurements.

### BACKGROUND

Optical measurements such as fluorescence and absorbance measurements are widely used in fields including, but not limited to, chemistry, biology, environmental analyses, and diagnostics. Such optical measurements typically require laboratory instruments (e.g., plate readers) that are not accessible or practical to use outside of a laboratory setting.

A variety of paper-based devices have been developed for applications such as point-of-care testing. Accordingly, there exists a need for low-cost, easy-to-use electronic readers configured to perform optical measurements on this type of device.

### SUMMARY

The technology disclosed herein provides electronic readers for performing optical measurements on samples present on porous matrices such as paper.

One aspect of the technology disclosed herein relates to an electronic reader for performing an optical measurement on a sample present on a porous matrix, wherein the reader comprises a light source, a cassette that supports the porous matrix, and a detecting module, and wherein the cassette is configured to be detachable.

In one embodiment, the cassette is disposed between the light source and the detecting module when the reader is in use.

In one embodiment, the light source and the detecting module are on the same side of the cassette.

In one embodiment, the reader is portable.

In one embodiment, the reader further comprises a housing, wherein the housing encloses the light source, cassette, and detecting module.

In one embodiment, the reader further comprises a printed circuit board.

In one embodiment, the light source comprises an array of light-emitting diodes.

In one embodiment, the light source comprises a laser.

In one embodiment, the light source comprises an array of optical fibers connected to a laser.

In one embodiment, the light source is diffuse.

In one embodiment, the detecting module comprises an array of photodiodes.

In one embodiment, the detecting module comprises a luminosity sensor.

In one embodiment, the detecting module comprises a sensor configured to collect an image.

In one embodiment, the detecting module comprises a charge-coupled device (CCD) or complementary metal oxide semiconductor sensor (CMOS sensor).

In one embodiment, the cassette comprises an array of apertures, and wherein when the reader is in use, light transmitted through the array of apertures is detected by the detecting module.

In one embodiment, the optical measurement is absorbance measurement.

In one embodiment, the optical measurement is fluorescence measurement.

In one embodiment, the optical measurement is colorimetric measurement.

In one embodiment, the optical measurement is luminescence measurement.

In one embodiment, the reader can relay a signal to a computing device.

Another aspect of the technology disclosed herein relates to a measurement system comprising an electronic reader as disclosed herein and at least one sample comprising a synthetic biological circuit on a porous matrix.

In one embodiment, the sample is lyophilized or frozen.

In one embodiment, the porous matrix comprises paper, quartz microfiber, mixed esters of cellulose, porous aluminum oxide, or a patterned surface.

In one embodiment, the porous matrix is a sheet of paper comprising wax patterns.

In one embodiment, the synthetic biological circuit is a synthetic gene network or an engineered signaling pathway.

In one embodiment, the synthetic gene network is a nucleic-acid-based sensor.

In one embodiment, a plurality of samples is distributed at measurement sites on the porous matrix, and the plurality of samples is aligned with the array of apertures in the cassette.

In one embodiment, the porous matrix comprises an identification tag.

Another aspect of the technology disclosed herein relates to a measurement system comprising an electronic reader as disclosed herein and at least one sample comprising a cell-free system on a porous matrix.

In one embodiment, the sample is lyophilized or frozen.

### DEFINITIONS

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are useful to an embodiment, yet open to the inclusion of unspecified elements, whether useful or not.

As used herein the term “consisting essentially of” refers to those elements required for a given embodiment. The term permits the presence of elements that do not materially affect the basic and novel or functional characteristic(s) of that embodiment of the invention.

As used herein, the term “portable” refers to a device that can be held by a person of ordinary strength in one or two hands, without the need for any special carriers. A portable device can be configured to be used outside of a laboratory setting. In certain embodiments, a portable device is, e.g., battery powered.

As used herein, the term “porous matrix” refers to a matrix that contain pores or interstices via which a liquid composition may penetrate the matrix surface. Paper is one example of a porous matrix.

As used herein, the terms “porous” and “porosity” are generally used to describe a structure having a connected network of pores or void spaces (which can, for example, be openings, interstitial spaces or other channels) throughout its volume. The term “porosity” is a measure of void spaces in a material, and is a fraction of volume of voids over the total volume, as a percentage between 0 and 100% (or between 0 and 1).

As used herein, the term “cell-free system” refers to a set of reagents capable of providing for or supporting one or more enzymatic and/or biosynthetic reactions (e.g., transcription reaction, translation reaction, or both) in vitro in the absence of cells. For example, to provide for a transcription reaction, a cell-free system comprises promoter-containing DNA, RNA polymerase, ribonucleotides, and a buffer system. Cell-free systems can be prepared using enzymes, coenzymes, and other subcellular components either isolated or purified from eukaryotic or prokaryotic cells, including recombinant cells, or prepared as extracts or fractions of such cells. A cell-free system can be derived from a variety of sources, including, but not limited to, eukaryotic and prokaryotic cells, such as bacteria including, but not limited to, E. coli, thermophilic bacteria and the like, wheat germ, rabbit reticulocytes, mouse L cells, Ehrlich's ascitic cancer cells, HeLa cells, CHO cells and budding yeast and the like.

The term “biosynthetic reaction” is used herein to refer to any reaction that results in the synthesis of one or more biological compounds (e.g., DNA, RNA, proteins, monosaccharides, polysaccharides, small molecules, etc.). For example, a transcription reaction is a biosynthetic reaction because RNA is produced. Other examples of biosynthetic reactions include, but are not limited to, translation reactions, coupled transcription and translation reactions, DNA synthesis, and polymerase chain reactions.

As used herein, the term “in vitro” refers to activities that take place outside an organism. In some embodiments, “in vitro” refers to activities that occur in the absence of cells. As used herein, a reaction occurring on a porous solid substrate in the absence of viable cells is an in vitro reaction.

The term “synthetic biological circuit” is used herein to refer to any engineered biological circuit where the biological components are designed to perform logical functions. In general, an input is needed to activate a synthetic biological circuit, which subsequently produces an output as a function of the input. In some embodiments, a synthetic biological circuit comprises at least one nucleic acid material or construct. In some embodiments, a synthetic biological circuit is substantially free of nucleic acids. A synthetic gene network is one kind of synthetic biological circuit. Other examples of synthetic biological circuits include, but are not limited to, an engineered signaling pathway, such as a pathway that amplifies input via kinase activity.

“Synthetic gene network” or “synthetic gene circuit” are used interchangeably herein to refer to an engineered composition that comprises at least one nucleic acid material or construct and can perform a function including, but not limited to, sensing, a logic function, and a regulatory function. The nucleic acid material or construct can be naturally occurring or synthetic. The nucleic acid material or construct can comprise DNA, RNA, or an artificial nucleic acid analog thereof. In some embodiments of a synthetic gene network comprising at least two nucleic acid materials or constructs, the nucleic acid materials or constructs can interact with each other directly or indirectly. An indirect interaction means that other molecules are required for or intermediate in the interaction. Some examples of synthetic gene networks comprise a nucleic acid operably linked to a promoter.

As used herein, the term “operably linked” indicates that a promoter is in a correct functional location and/or orientation in relation to a nucleic acid sequence it regulates to control transcriptional initiation and/or expression of that sequence.

As used herein, the terms “nucleic acid,” “polynucleotide,” and “oligonucleotide” are used interchangeably to generally refer to any polyribonucleotide or poly-deoxyribonucleotide, and includes unmodified RNA, unmodified DNA, modified RNA, and modified DNA. Polynucleotides include, without limitation, single- and double-stranded DNA and RNA polynucleotides. The term “nucleic acid” embraces chemically, enzymatically or metabolically modified forms of polynucleotides, as well as the naturally occurring chemical forms of DNA and RNA found in or characteristic of viruses and cells, including for example, simple (prokaryotic) and complex (eukaryotic) cells. A nucleic acid polynucleotide or oligonucleotide as described herein retains the ability to hybridize to its cognate complimentary strand. An oligonucleotide is not necessarily physically derived from any existing or natural sequence, but can be generated in any manner, including chemical synthesis, DNA replication, DNA amplification, in vitro transcription, reverse transcription or any combination thereof.

As used herein, a “promoter” refers to a control region of a nucleic acid sequence at which initiation and rate of transcription of the remainder of a nucleic acid sequence are controlled. A promoter can also contain sub-regions at which regulatory proteins and molecules can bind, such as RNA polymerase and other transcription factors. Promoters can be constitutive, inducible, activatable, repressible, tissue-specific or any combination thereof. A promoter drives expression or drives transcription of the nucleic acid sequence that it regulates.

As used herein, the term “signaling pathway” refers, unless context dictates otherwise, to the components of a signaling pathway. Thus, reference to a “signaling pathway” lyophilized on a porous matrix refers to components necessary for the signaling pathway of interest, lyophilized on the porous matrix. Similarly, reference to a “gene network” lyophilized on a porous matrix is a reference to the components of such a network lyophilized on the matrix.

The term “template-directed synthetic reaction” is used herein to refer to a synthetic reaction for which a nucleic acid template guides the pattern of nucleic acid or amino acid addition to a nucleic acid or polypeptide polymer. DNA replication and transcription are template-directed synthetic reactions that produce DNA or RNA products, respectively using a DNA template. Reverse transcription produces a DNA product using an RNA template. Translation is a template-directed synthetic reaction that produces a polypeptide or protein using an RNA template.

The terms “active” or “activated” are used interchangeably herein to refer to the readiness of a sample described herein or a portion thereof to perform an innate function or task. Reaction components lyophilized on a porous matrix are “activated” by addition of water or an aqueous sample, regaining transcription and/or translation activities. In some embodiments, the composition or a portion thereof performs the function or task when it's active or activated. In other embodiments, the composition or a portion thereof does not perform the function or task when it's active or activated, but is ready to do so when an external factor (an analyte or trigger as non-limiting examples) is provided. At a minimum, a lyophilized reaction/component mixture that regains at least 3% of its original activity upon re-hydration is considered “active.” Preferably the mixture regains at least 10%, at least 12%, at least 15%, at least 18%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95% or more of its original activity (i.e., activity just prior to lyophilization). The regained activity is comparable to the original activity when the difference between the two is no more than 20%.

As used herein, the term “sample,” means any sample comprising or being tested for the presence of one or more analytes. Such samples include, without limitation, those derived from or containing cells, organisms (bacteria, viruses), lysed cells or organisms, cellular extracts, nuclear extracts, components of cells or organisms, extracellular fluid, media in which cells or organisms are cultured in vitro, blood, plasma, serum, gastrointestinal secretions, ascites, homogenates of tissues or tumors, synovial fluid, feces, saliva, sputum, cyst fluid, amniotic fluid, cerebrospinal fluid, peritoneal fluid, lung lavage fluid, semen, lymphatic fluid, tears, pleural fluid, nipple aspirates, breast milk, external secretions of the skin, respiratory, intestinal, and genitourinary tracts, and prostatic fluid. A sample can be a viral or bacterial sample, a sample obtained from an environmental source, such as a body of polluted water, an air sample, or a soil sample, as well as a food industry sample. A sample can be a biological sample which refers to the fact that it is derived or obtained from a living organism. The organism can be in vivo (e.g. a whole organism) or can be in vitro (e.g., cells or organs grown in culture). A sample can be a biological product. In one embodiment, a “biological sample” also refers to a cell or population of cells or a quantity of tissue or fluid from a subject. Often, a “biological sample” will contain cells from a subject, but the term can also refer to non-cellular biological material, such as non-cellular fractions of blood, saliva, or urine, that can be used to measure analyte or enzyme activity levels, for example, upon rehydration. Biological samples also include explants and primary and/or transformed cell cultures derived from patient tissues. A biological sample can be provided by removing a sample of cells from subject, but can also be accomplished by using previously isolated cells or cellular extracts (e.g., isolated by another person, at another time, and/or for another purpose). Archival tissues, such as those having treatment or outcome history can also be used. Biological samples include, but are not limited to, tissue biopsies, scrapes (e.g. buccal scrapes), urine, or cell culture. Biological samples also include tissue biopsies, cell culture. The term “sample” also includes untreated or pretreated (or pre-processed) samples. For example, a sample can be pretreated to increase analyte concentration.

As used herein, the term “trigger” refers to a composition, molecule, or compound that can activate a synthetic gene network.

The term “analyte” is used herein to refer to a substance or chemical constituent in a sample (e.g., a biological or industrial fluid) that can be analyzed (e.g., detected and quantified) and monitored using the sensors described herein. Examples of an analyte include, but are not limited to, a small inorganic or organic molecule, an ion, a nucleic acid (e.g., DNA, RNA), a polypeptide, a peptide, a monosaccharide, a polysaccharide, a metabolic product, a hormone, an antigen, an antibody, a biological cell, a virus, and a liposome.

The singular terms “a,” “an,” and “the” include plural referents unless context clearly indicates otherwise. Similarly, the word “or” is intended to include “and” unless the context clearly indicates otherwise.

Other than in the operating examples, or where otherwise indicated, all numbers expressing quantities of ingredients or reaction conditions used herein should be understood as modified in all instances by the term “about.” The term “about” when used in connection with percentages may mean±1% of the value being referred to. For example, about 100 means from 99 to 101.

Although methods and materials similar or equivalent to those disclosed herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

### BRIEF DESCRIPTION OF THE DRAWINGS

FIG. 1A is a diagram of an electronic reader in accordance with some embodiments of the invention. The assembly on the left is a cassette to support porous matrix-based synthetic gene networks. Three, twelve, and 48 prototype reaction versions of the readers have been built, with the three reaction device being pictured here.

FIG. 1B is a diagram illustrating the cassette secured in the electronic reader.

FIG. 1C is a schematic illustrating that light produced by a light source transmits through the cassette and then gets detected by a sensor. Wavelength of the light source can be selected, for example, to match the absorbance maximum of the enzyme reaction product. For example, LacZ cleaves the yellow chlorophenol Red-β-D-galactopyranoside substrate to produce the purple chlorophenol red product, which has an absorbance maximum of ˜570 nm. One exemplary device use LEDs with a peak emission to substantially match the absorbance maximum.

FIG. 1D is a photograph of a cassette prototype.

FIG. 1E is a photograph of an electronic reader prototype. The electronic reader can perform time course and endpoint measurements for three reactions.

FIG. 1F is a photograph of an electronic reader for the twelve reaction prototype.

FIG. 1G is a set of photographs of an electronic reader monitoring colorimetric reactions. The reader is incubated at 37° C. for the duration of the reaction. While the reaction will proceed at room temperature, warmer temperature accelerates the process. The electronic reader can include a controlled heat source to promote or accelerate biochemical reactions. The reader can have a storage module (e.g., an SD data storage card) or could be connected directly or wirelessly to portable electronics.

FIG. 2A is a graph of experimental results indicating that the output from freeze dried synthetic gene networks on paper can be monitored using the electronic reader designed to detect the light absorbance spectrum.

FIG. 2B is a graph of a titration series of a trigger RNA used to activate a toe-hold switch. Activation results in the expression of LacZ and a color change that can be measured by the electronic reader. Concentrations tested ranged from 3 micromolar down to 300 picomolar.

FIGS. 3A-3B are schematics indicating that the electronic reader can be used to screen large numbers of reactions in paper disc or quartz disc arrays. Here Toe-hold switches are being tested for orthogonality against the full set of complementary trigger RNAs in (FIG. 3A) fluorescent mode and (FIG. 3B) colorimetric output mode.

FIG. 4 is a circuit diagram for an electronic reader capable of measuring twelve reactions.

FIG. 5 is a schematic illustrating the three layers which make up the measurement portion of an electronic reader according to one embodiment. The top layer 210 is made up of 48 LED light sources (570 nm) held in place between two pieces of acrylic. The grey middle layer 220 is a cassette for supporting a porous matrix comprising at least one sample (e.g., paper discs or printed arrays) and the bottom layer 232 holds an array of 48 detectors 230, with electrical connectors 234 projecting below.

FIG. 6 is a photograph of a 48-reaction electronic reader prototype.

FIG. 7 is a schematic of a printed array for hosting samples.

### DETAILED DESCRIPTION

Described herein is an electronic reader configured to perform an optical measurement on a sample present on a porous matrix. The sample can be partially or completely embedded in the porous matrix. The electronic reader was found to be as much as 100 times more sensitive than a standard plate reader for measuring a signal from a paper-based device. In various embodiments, the reader described herein can be at least 5×, at least 10×, at least 20×, at least 50×, at least 100× more sensitive for reading a signal from a paper-based reaction substrate than a standard microtiter plate reader (e.g., Biotek Synergy NEO HTS Multi Mode microplate reader).

Preferably, the porous matrix is thin, e.g., no more than 1 mm.

The porous matrix can be in any form including, but not limited to, a well, a tube, a planar substrate (e.g., a chip, a sheet, or a plate), a sphere, a porous substrate (e.g., a mesh or a foam), a 3D scaffold, a patterned surface (e.g., nano-patterns, or micro-patterns, or both), a porous or solid bead, a hydrogel, a channel (e.g., a microfluidic channel), a smooth surface, and a rough surface. In a preferred embodiment, the porous matrix is hydrophilic. Preferred matrices include a sheet or a disc. In one embodiment, the sheet is patterned with hydrophilic regions delimited by surrounding hydrophobic regions.

A patterned surface can be physically or chemically patterned, or both. A physically patterned surface is textured, and can comprise nano-patterns, micro-patterns, or both. A chemically patterned surface typically comprises hydrophilic molecules and/or hydrophobic molecules attached to the surface in a desired pattern. For example, a hydrophobic surface can be patterned with hydrophilic molecules to render certain regions hydrophilic. Methods of producing physically or chemically patterned surfaces are known in the art.

In a preferred embodiment, the porous matrix comprises a matrix capable of high capillary action. High capillary action enables even distribution of a small volume of liquid over a large surface area without the use of a pump.

In a preferred embodiment, the porous matrix comprises paper. Papers applicable in the technology described herein can include, but are not limited to, printing paper, wrapping paper, writing paper, drawing paper, specialty paper (for example, chromatography paper, filter paper, e.g., Whatman™ filter paper), handmade paper, or blotting paper. The use of paper confers several advantages: low cost, light weight, and thin cross section. Additionally, white paper can act as a surface for displaying optical signals (e.g., fluorescence, luminescence, or visible color).

In one embodiment, the paper can be hydrophobic. For example, hydrophobic paper can become hydrophilic after treatment by a laser (Chitnis et al., Lab Chip 2011, 11, 1161), therefore one can create hydrophilic regions on hydrophobic paper by selective laser scanning.

In one embodiment, the porous matrix can comprise quartz microfiber, mixed esters of cellulose, cellulose acetate, silk, porous aluminum oxide (e.g., anopore membrane), or regenerated membrane.

In one embodiment, the porous matrix can comprise 1, 2, 3, 4, 5, 6, 7, 8, 9, 10, 20, or more spatially distinct reaction regions where the samples can be confined. The area that contains a sample is herein referred to as “a reaction region.” By way of example only, reaction regions can be created by a chemical process such as using hydrophobic barriers on a piece of paper. The hydrophobic barriers are minimally permeable by water. The hydrophobic barrier can comprise hydrophobic materials such as hydrophobic polymer or wax. The hydrophobic barrier can be patterned by any existing patterning method (e.g., micro-contact printing, or dip pen lithography, photolithography, e-beam lithography, laser printing, inject printing, or a micro-arrayer). Methods of creating hydrophobic patterns on paper are known in the art; see for example, WO2009121041 and WO2008/049083, the contents of each of which are incorporated by reference for the hydrophobic patterning methods.

The reaction regions can be arranged in a random or pre-determined pattern (e.g., linear, periodic, or pseudo-periodic). The reaction regions can be patterned on the porous matrix using a patterning device (e.g., a laser printer, an inject printer or a micro-arrayer). The reaction regions can also be created by a physical process such as producing wells on the porous matrix.

In one embodiment, the porous matrix can be in the form of a multi-layer reaction chip. The reaction chip can comprise a sample hosting layer, a light blocking layer, a hydration layer, a transparent layer, a humidity maintaining layer, and a water vapor permeable layer. The hydration layer can comprise a hydrated material or chamber that provides humidity during incubation and/or measurement. The humidity maintaining layer can be water impermeable. The water vapor permeable layer can regulate humidity for the sample.

In one embodiment, the porous matrix can further comprise an identification tag (e.g., a barcode or a radio-frequency identification tag).

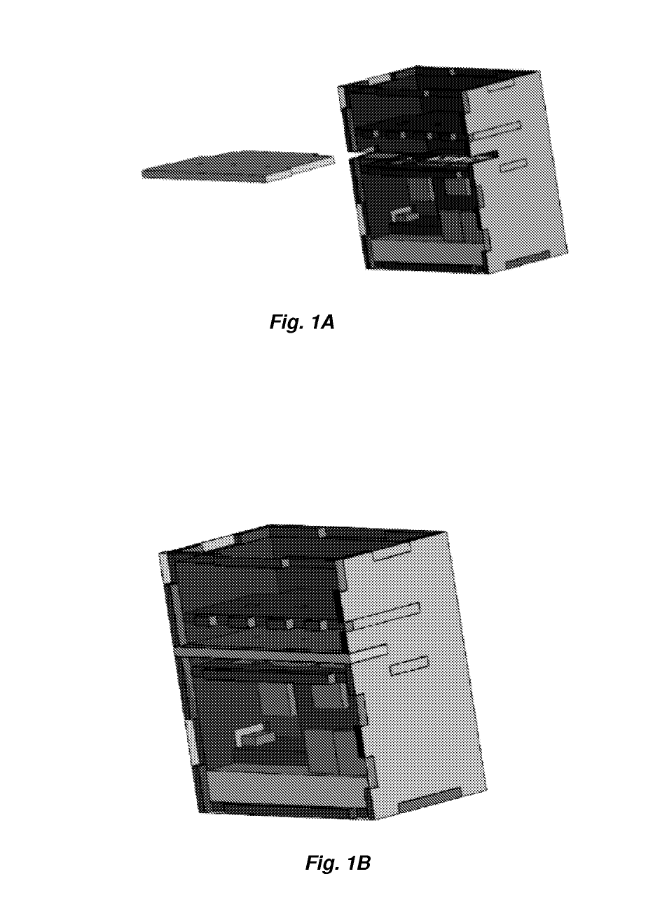

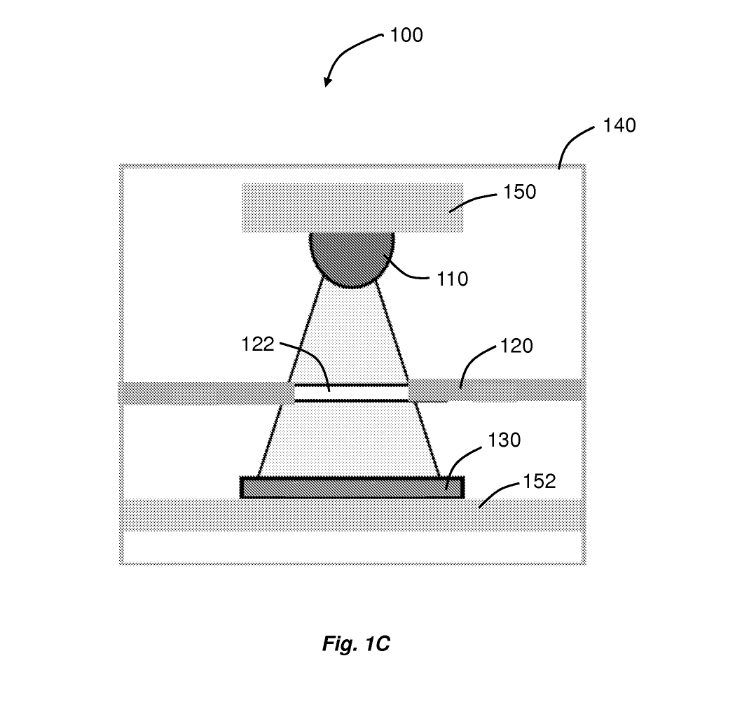

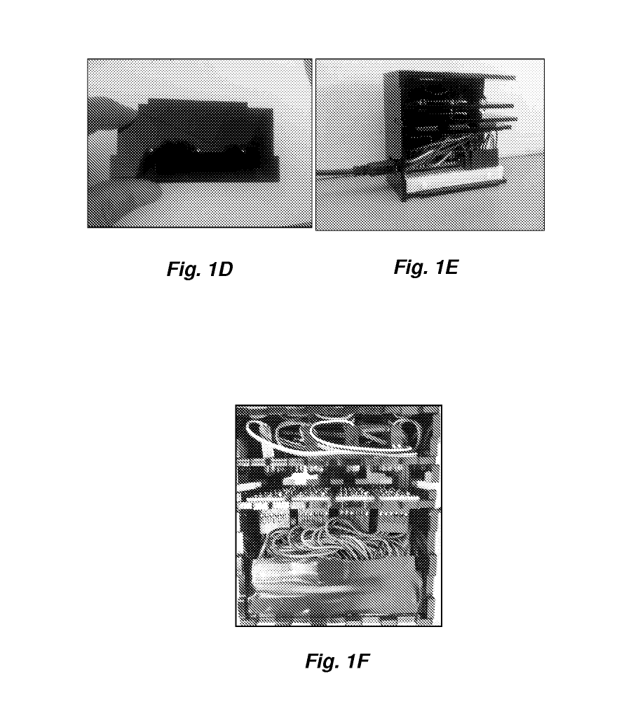

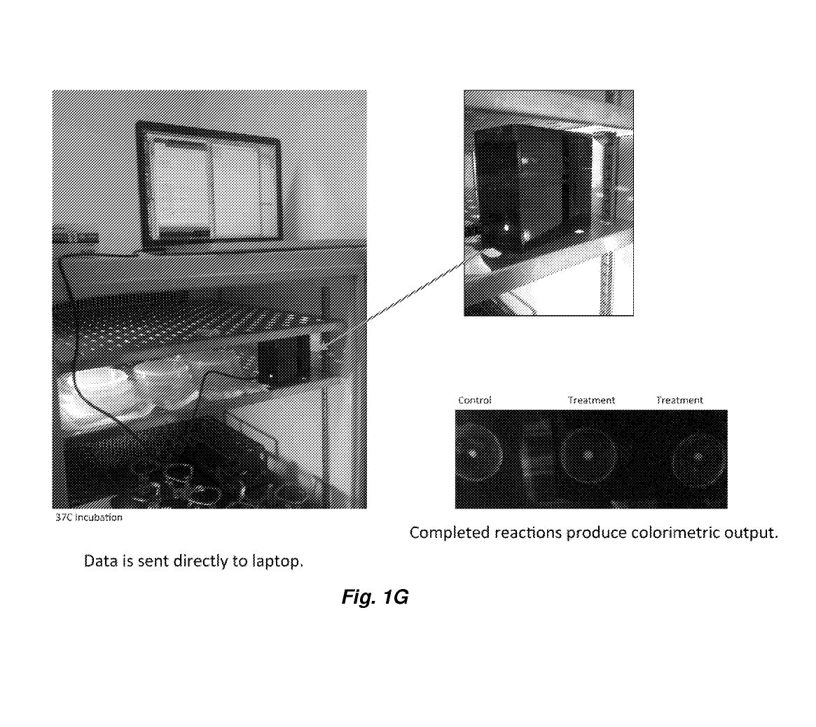

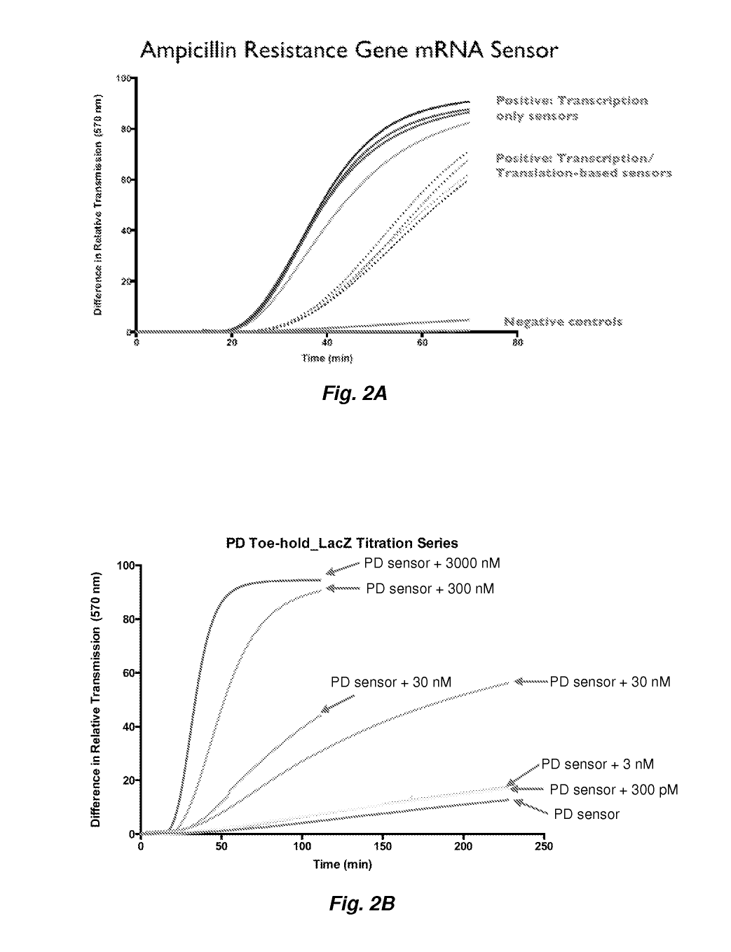

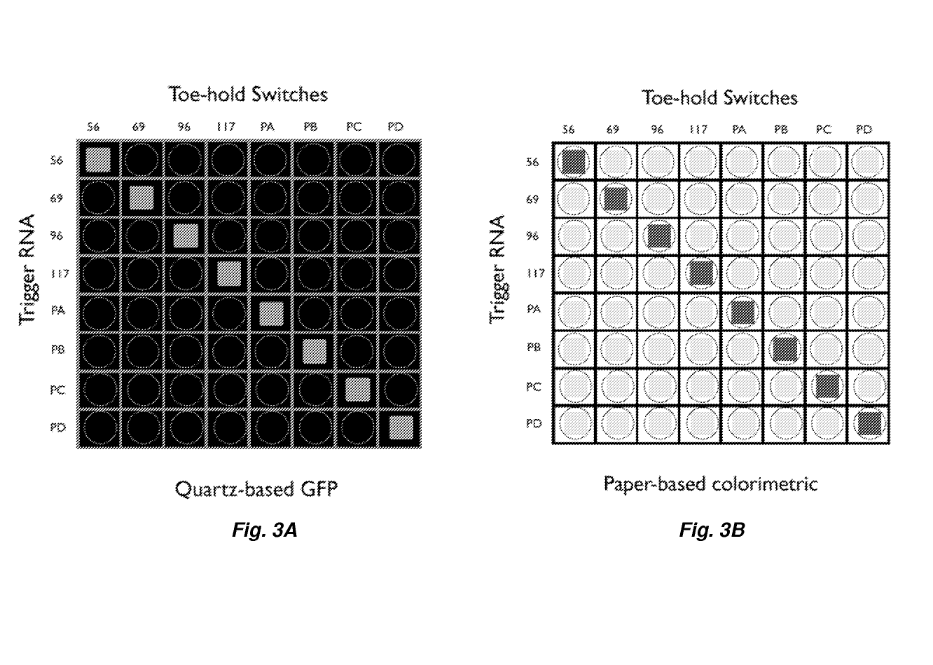

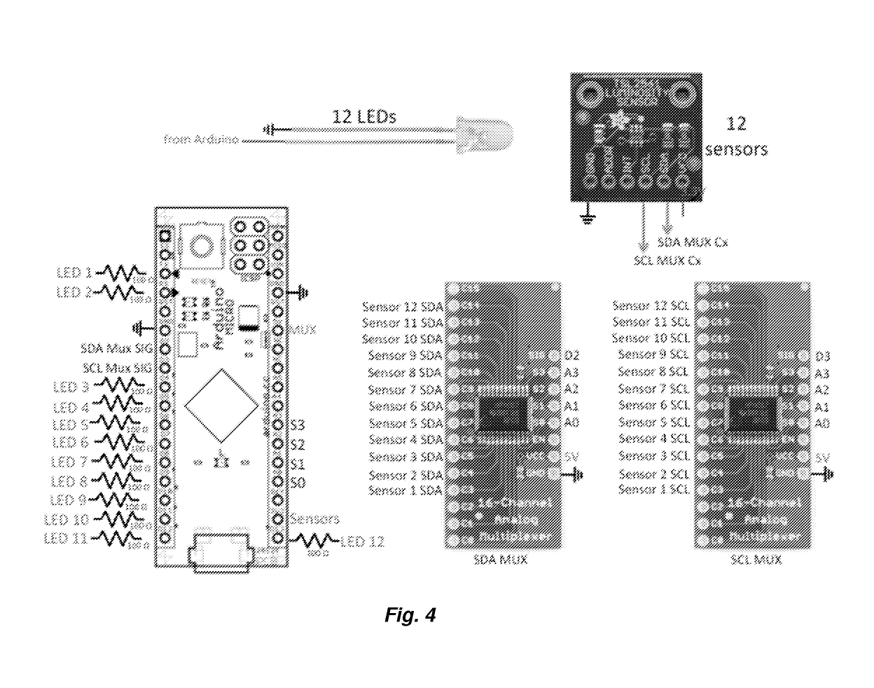

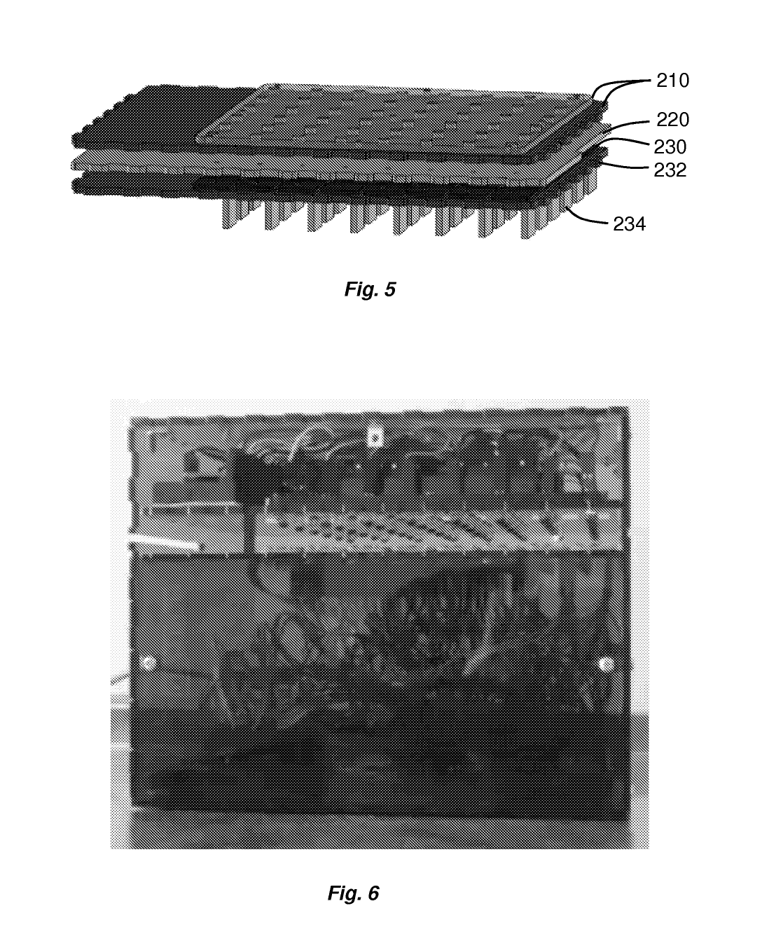

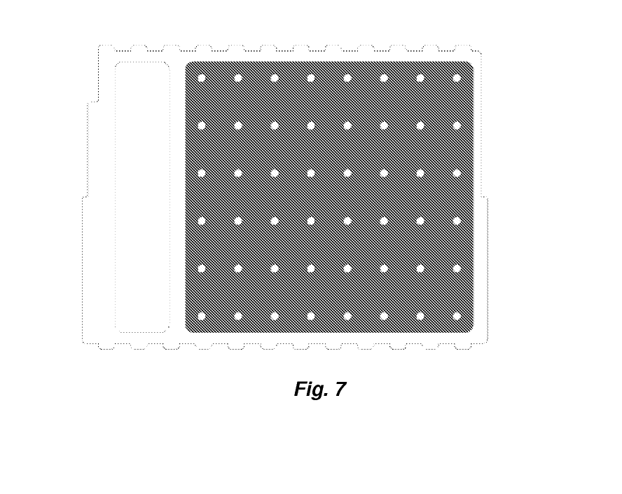

FIG. 1C illustrates a cross section of an electronic reader 100 in accordance with some embodiments of the invention. The electronic reader 100 can comprise a light source 110 for illuminating a sample present on a porous matrix, a cassette 120 for supporting the porous matrix, and a detecting module 130 for detecting an optical signal from the sample. Optionally, the electronic reader 100 can further comprise a housing 140 that encloses the light source 110, cassette 120, and detecting module 130. In one embodiment, the housing 140 can substantially block ambient light from reaching the detecting module 130 when the electronic reader 100 is in use.

In one embodiment, the cassette 120 can be disposed between the light source 110 and the detecting module 130. This configuration is particularly useful for light absorbance measurements.

In one embodiment, the light source 110 and the detecting module 130 can be on the same side of the cassette 120. This configuration is useful, e.g., for reflectance measurement.

The light source 110 can be mounted and immobilized on a first solid support 150. In one embodiment, the light source 110 can comprise an array of light-emitting diodes (LEDs). In one embodiment, the light source 110 can comprise one or more lasers. A single laser beam can be split into an array of beams, e.g., through an array of optical fibers. Alternatively, a single beam can be scanned over an array of locations on the cassette 120. Laser scanning can be done, for example, using an oscillating mirror.

Each of the LEDs or laser(s) can provide light having a center wavelength. The LEDs or laser(s) can be arranged in a geometric (e.g., circular or rectangular), random, or spatially displaced array. Each of the LEDs or laser(s) can be controlled independently. Alternatively, the plurality of LEDs or laser(s) (e.g., 2, 3, 4, 5, 6, 7, 8, 9, or more) can be controlled simultaneously. As is known by those skilled in the art, selection of the wavelength of the light source 110 should depend on the specific applications and samples being probed. For light absorbance measurements, the wavelength of the light source 110 can be at which the absorbance by the sample or output product to be detected is maximum.

In one embodiment, the light source 110 can be broadband. Band-pass filters can be used to select light with a narrow wavelength range, the range of which is determined by the bandwidths of the filters. Examples of broadband light sources include, but are not limited to, red-green-blue (RGB) LEDs, phosphor-based LEDs, tungsten halogen lamps, and supercontinuum lasers.

In one embodiment, the light source 110 can be diffuse. A diffuse light source can be used to simultaneously illuminate all samples or portions thereof. The diffuse light source can be in the form of a sheet (e.g., electroluminescent panels or printed LED sheet).

The detecting module 130 can be mounted and immobilized on a second solid support 152. In one embodiment, the detecting module 130 can comprise an array of photodetectors. Generally, the photodetector can be any photodetector that is sensitive to photons, including, but not limited to, a photodiode and a photomultiplier.

In one embodiment, the detecting module 130 can comprise a luminosity sensor.

In one embodiment, the detecting module 130 can comprise a sensor configured to collect an image, such as a charge-coupled device (CCD) or an active-pixel-sensor (APS) (e.g., a metal-oxide-semiconductor (CMOS) sensor). The sensor configured to collect an image can be monochromatic or color. A sensor configured to collect an image is particularly useful when the light source 110 is diffuse.

In one embodiment, the detecting module 130 can be Adafruit TSL2591 High Dynamic Range Digital Light Sensor.

The cassette 120 is configured to be detachable. When the cassette 120 is detached, the porous matrix can be positioned on or held by the cassette 120 for optical measurements. In one embodiment, the cassette 120 can comprise one or more apertures 122 (e.g., 2, 3, 4, 5, 6, 7, 8, 9, or more). When the porous matrix comprising a sample is positioned on or held by the cassette 120, a portion of the sample should be in contact with or aligned with one of the apertures 122. The apertures 122 should also be in alignment with the light source 110 and the detecting module 130, such that when the electronic reader 100 is in use, light transmitted through the apertures 122 can get detected by the detecting module 130. In one embodiment, the cassette 120 can comprise immobilization means (e.g., a clamp, a pin, etc.) for immobilizing the porous matrix.

The cassette 120 and/or housing 140 can comprise or be comprised of a metal, a metal alloy, or a polymer. In one embodiment, the cassette 120 and/or housing 140 can comprise acrylics.

In some embodiments, the electronic reader 100 can further comprise a printed circuit board. The printed circuit board can be used to control the light source 110 and/or the detecting module 130. In one embodiment, the printed circuit board can be a commercially available or substantially similar microcontroller, such as an Arduino or Raspberry Pi. Arduino is an open-source microcontroller board line. The Arduino microcontroller can be programmed through the Arduino Integrated development Environment (IDE). The Arduino IDE includes a C/C++ library that provides custom functions for setting up the functions of the microcontroller board. In one embodiment, the printed circuit board can comprise a field programmable gate array. In one embodiment, the printed circuit board can control the on/off of the light source 110. In one embodiment, the printed circuit board can actuate the detecting module 130. In one embodiment, the printed circuit board can process the signal collected by the detecting module 130.

In one embodiment, the electronic reader 100 can relay a signal to a computing device wirelessly or via a cable. Non-limiting examples of a computing device applicable to the electronic reader 100 include computers, smart phones, tablets, laptops, and gaming systems such as Xbox® and Wii®. As a non-limiting example, the electronic reader 100 can be connected to a computer using a USB (universal serial bus) cable, and the computer can provide power to the reader, control the reader, and receive signals from the reader.

In one embodiment, the electronic reader 100 can include a storage module. The storage module is configured to store output data from the detecting module 130. As used herein the “storage module” is intended to include any suitable computing or processing apparatus or other device configured or adapted for storing data or information. Examples of electronic apparatus suitable for use with the present invention include stand-alone computing apparatus, data telecommunications networks, including local area networks (LAN), wide area networks (WAN), Internet, Intranet, and Extranet, and local and distributed computer processing systems. Storage modules also include, but are not limited to: magnetic storage media, such as floppy discs, hard disc storage media, magnetic tape, optical storage media such as CD-ROM, DVD, electronic storage media such as RAM, ROM, EPROM, EEPROM and the like, general hard disks and hybrids of these categories such as magnetic/optical storage media. The storage module is adapted or configured for having recorded thereon, for example, sample name, light intensity, etc. Such information may be provided in digital form that can be transmitted and read electronically, e.g., via the Internet, on diskette, via USB or via any other suitable mode of communication.

As used herein, “store” refers to a process for encoding information on the storage module. Those skilled in the art can readily adapt any of the presently known methods for recording information on known media to generate manufactures comprising measurement results.

In one embodiment, the electronic reader 100 can be portable. The reader can be powered, e.g., by a battery. In one embodiment, the electronic reader 100 can be a benchtop laboratory device.

In general, the electronic readers disclosed herein can be used to illuminate a sample present on a porous matrix with light and detect an optical signal as a result of the illumination. In one embodiment, the optical measurement is an absorbance measurement. In one embodiment, the optical measurement is a fluorescence measurement. In one embodiment, the optical measurement is a colorimetric measurement. In one embodiment, the optical measurement is a luminescence measurement.

Without limitation, other examples of optical measurements include time-resolved fluorescence measurements, fluorescence polarization measurements, light scattering measurements, plasmonic measurements, ultraviolet spectrophotometry, and infrared or near-infrared spectrophotometry. In one embodiment, the photometric or spectrophotometric measurement is not Raman spectroscopy.

In one aspect, the technology disclosed herein relates to a measurement system comprising an electronic reader as disclosed herein and at least one sample comprising a cell-free system on a porous matrix.

In another aspect, the technology disclosed herein relates to a measurement system comprising an electronic reader as disclosed herein and at least one sample comprising a synthetic biological circuit on a porous matrix within or on the cassette of the reader.

In one embodiment, the sample comprises a cell-free system that comprises components for a template-directed synthetic reaction. In one embodiment, the cell-free system is lyophilized on the porous matrix, and can become active for the template-directed synthetic reaction upon re-hydration. In one embodiment, the cell-free system is frozen on the porous matrix, and can become active for the template-directed synthetic reaction after thawing.

In one embodiment, a template-directed synthetic reaction is a transcription reaction, and the components sufficient for the transcription reaction comprise promoter-containing DNA, RNA polymerase, ribonucleotides, and a buffer system. Examples of RNA polymerases include, but are not limited to, T3 RNA polymerase, T7 RNA polymerase, and SP6 RNA polymerase.

In one embodiment, a template-directed synthetic reaction is a translation reaction, and the components sufficient for the translation reaction comprise ribosomes, aminoacyl transfer RNAs, translation factors, and a buffer system. Components of translation factors are disclosed in Shimizu and Ueda, “Pure Technology,” Cell-Free Protein Production: Methods and Protocols, Methods in Molecular Biology, Endo et al. (Eds), Humana 2010; and Shimizu et al., “Cell-free translation reconstituted with purified components,” Nature Biotechnology 2001, 19, 751-755. For example, in E. coli, the translation factors responsible for protein biosynthesis are three initiation factors (IF1, IF2, and IF3), three elongation factors (EF-G, EF-Tu, and EF-Ts), and three release factors (RF1, RF2, and RF3), as well as RRF for termination. Exemplary cell-free systems for synthesis of proteins are disclosed in U.S. Pat. No. 6,780,607, U.S. Pat. No. 8,445,232, US20090317862, US20130053267, WO2013067523, WO2014122231, the contents of each of which are incorporated by reference in their entirety.

In one embodiment, a template-directed synthetic reaction is a coupled transcription and translation reaction, and the components sufficient for the coupled transcription and translation reaction comprise promoter-containing DNA, RNA polymerase, ribonucleotides, ribosomes, aminoacyl transfer RNAs, translation factors, and a buffer system. In a coupled transcription and translation reaction, DNA is transcribed into mRNA and the mRNA is subsequently translated into proteins, as described in Current Protocols in Molecular Biology (F. M. Ausubel et al. editors, Wiley Interscience, 2002), which is incorporated by reference herein.

In one embodiment, a template-directed synthetic reaction is DNA synthesis, and the components sufficient for the DNA synthesis comprise DNA polymerase, deoxyribonucleotides, and a buffer system. The DNA polymerase can be, but need not necessarily be, a thermostable DNA polymerase.

In one embodiment, a template-directed synthetic reaction is a polymerase chain reaction (PCR), and the components sufficient for PCR comprise a DNA template, primers, thermostable polymerase, deoxynucleoside triphosphates, and a buffer system.

In one embodiment, the cell-free system comprises a whole cell extract. The whole cell extract can be an extract from any cell type from any organism. For example, the whole cell extract can be rabbit reticulocyte lysate, rabbit oocyte lysate, wheat germ extract, E. coli extract, a mammalian cell extract (e.g., human cell extract). Eukaryotic extracts or lysates may be preferred when the resulting protein is glycosylated, phosphorylated or otherwise modified because many such modifications are only possible in eukaryotic systems. Commercial whole cell extracts are widely available through vendors such as Thermo Scientific, Life Technologies, New England Biolabs Inc., Sigma Aldrich, and Promega. Membranous extracts, such as the canine pancreatic extracts containing microsomal membranes, are also available which are useful for translating secretory proteins. Mixtures of purified translation factors have also been used successfully to translate mRNA into protein as well as combinations of lysates or lysates supplemented with purified translation factors such as initiation factor-1 (IF-1), IF-2, IF-3 (α or β), elongation factor T (EF-Tu), or termination factors.

In one embodiment, the cell-free system comprises a recombinant protein transcription/translation system. In one embodiment, the recombinant protein transcription/translation system permits protein synthesis using recombinant elements (PURE) or PURExpress® (New England Biolabs, Ipswich, Mass.) cell-free transcription/translation system. PURExpress® is a cell-free transcription/translation system reconstituted from the purified components necessary for E. coli translation.

In one embodiment, the cell-free system can initiate a template-directed synthetic reaction simply upon rehydration.

In another embodiment, the cell-free system becomes activated for a template-directed synthetic reaction upon rehydration, but an input (e.g., an appropriate analyte) is needed to initiate the reaction.

In one embodiment, the cell-free system is embedded partially or completely in the porous matrix. In one embodiment, the cell-free system is on a surface of the porous matrix.

In one embodiment, the sample further comprises a synthetic gene network.

Examples of synthetic gene networks include, but are not limited to, a sensor, a switch, a counter, a timer, a converter, a toggle, a logic gate (e.g., AND, NOT, OR, NOR, NAND, XOR, XAND, XNOR, A IMPLY B, A NIMPLY B, B IMPLY A, B NIMPLY A, or a combination thereof), or a memory device (e.g., volatile or non-volatile). Examples of synthetic gene networks can also be found in U.S. Pat. No. 6,737,269, US20100175141, US20120003630, US20130009799, US20130034907, and WO2014093852, the contents of each of which are incorporated by reference in their entirety. For example, WO2014093852 describes 16 logic gates based on synthetic gene networks: AND, OR, NOT A, NOT B, NOR, NAND, XOR, XNOR, A IMPLY B, B IMPLY A, A NIMPLY B, B NIMPLY A, A, B, FALSE and TRUE. Methods of constructing synthetic gene networks are also disclosed, for example, in Synthetic Gene Networks, Weber and Fussenegger (Eds.) 2012, Humana Press, the contents of which are incorporated by reference in their entirety. The synthetic gene network is also lyophilized on the porous matrix, and resides in the same reaction region as the cell-free system. Similar to the cell-free system, the synthetic gene network can become active upon rehydration. Demonstrations of synthetic gene networks lyophilized on a porous matrix can be found in Pardee et al., “Paper-based synthetic gene networks”, Cell 2014, 159, 940-954, the contents of which are incorporated herein by reference in their entirety.

In one embodiment, the synthetic gene network comprises 1, 2, 3, 4, 5, 6, 7, 8, 9, 10, or more nucleic acids. The nucleic acid comprises DNA, RNA, an artificial nucleic acid analog, or a combination thereof.

In some embodiments, the synthetic gene network functions as a sensor. In one embodiment, the sensor can detect an analyte. When the analyte contacts the sensor in the presence of water, the analyte can activate the sensor, which can produce an optical signal, indicating the detection of the analyte. Without limitation, an optical signal can be fluorescence, luminescence, absorption or reflection of a given wavelength, ultraviolet, visible color, or infrared. The optical signal can be detected by the detecting module of the electronic reader disclosed herein. In one embodiment, the analyte is a small molecule and the sensor can be referred to as a small molecule sensor. As used herein, the term “small molecule” refers to a natural or synthetic molecule having a molecular mass of less than about 5 kD, organic or inorganic compounds having a molecular mass of less than about 5 kD, less than about 2 kD, or less than about 1 kD.

In one embodiment, the sensor comprises a reporter component. The function of the reporter component is to produce a detectable signal when an analyte is detected. In one embodiment, a reporter component can be used to quantify the concentration, strength, or activity of the input received by the sensor. In one embodiment, the reporter component comprises a reporter gene. The reporter gene can encode, for example, any fluorescent protein. Examples of fluorescent proteins include, but are not limited to, GFP, mCherry, Venus, and Cerulean. Examples of genes encoding fluorescent proteins include, without limitation, those proteins provided in U.S. Patent Application No. 2012/0003630 (see Table 59), incorporated herein by reference.

Similarly, the synthetic gene network can comprise a reporter gene encoding any enzyme. Enzymes that produce colored substrates (“colorimetric enzymes”) can also be used for visualization and/or quantification. Enzymatic products can be quantified by the electronic reader disclosed herein. Examples of genes encoding colorimetric enzymes include, without limitation, lacZ alpha fragment, lacZ (encoding beta-galactosidase, full-length), and xylE. In another example, a nuclease enzyme can cleave a nucleic acid sequence such that an optical signal is generated. In yet another example, an enzyme can separate a fluorescence resonance energy transfer (FRET) or quenching pair to induce a change in fluorescence.

For non-limiting examples of reporter genes, see Reporter Genes: A Practical Guide, D. Anson (Ed.), 2007, Humana Press, the contents of which are incorporated by reference for examples on reporter genes.

The synthetic gene network can comprise a reporter gene encoding luciferases. Luciferases produce luminescence, which can be readily quantified using the electronic reader disclosed herein. Examples of genes encoding luciferases include, without limitation, dmMyD88-linker-Rluc, dmMyD88-linker-Rluc-linker-PEST191, and firefly luciferase (from Photinus pyralis).

In one embodiment, the reporter component comprises a catalytic nucleic acid including, but not limited to, a ribozyme, an RNA-cleaving deoxyribozyme, a group I ribozyme, RNase P, a Hepatitis delta ribozyme, and DNA-zymes. The use of catalytic nucleic acid as reporters is described in WO1996027026.

In one embodiment, the reporter component comprises a fluorophore, a metabolite, or protein, wherein the fluorophore, metabolite, or protein can couple to a nucleic acid to produce a change in fluorescence. For example, RNA-fluorophore complexes have been reported (see, e.g., Paige et al., Science 2011, 333, 642-646). RNA binding to metabolites or proteins can also lead to a change in fluorescence (see, e.g., Strack et al., Nature Protocols 2014, in press). In one embodiment, the nucleic acid can be the analyte. In another embodiment, the nucleic acid can be transcribed due to the detection of an analyte.

In one embodiment, the sensor is an RNA sensor. The RNA sensor can detect a full-length RNA or a fragment thereof. In one embodiment, the RNA sensor can detect messenger RNA (mRNA).

In one embodiment, an RNA sensor was created based on the principles of toe-hold switches. The rational programmability of toehold switches comes from their design. Riboregulators are composed of two cognate RNAs: a transducer RNA that encodes the output signal of the system (e.g. a GFP mRNA) and a trigger RNA that modulates the output signal. Conventional riboregulators have historically repressed translation by sequestering the ribosomal binding site (RBS) of the transducer RNA within a hairpin. This hairpin is unwound upon binding of a cognate trigger RNA, exposing the RBS and enabling translation of the downstream protein. However, this design restricts the potential trigger RNAs to those that contain RBS sequences. Toehold switches have removed this constraint by moving the RBS to a loop region of the hairpin, leaving the trigger RNA binding site free to adopt virtually any sequence. The transducer or “switch” RNA of toehold switches also contains a single-stranded domain known as a toehold its 5′ end. This toehold domain, first developed in in vitro molecular programming studies (Yurke, B., et al., Nature 2000, 406, 605-608), provides the initial reaction site for binding between the trigger and switch RNAs and greatly improves the ON/OFF ratio of the switches. Examples of RNA sensors based on toehold switches can be found, for example, in WO2014074648, the contents of which are incorporated by reference in their entirety.

A wide range of fluorescent or colorimetric sensors based on lyophilized synthetic gene networks has been demonstrated. In one example of an RNA sensor, the reporter component comprises the gene that encodes the enzyme LacZ. The analyte being detected is a specific RNA molecule, which can activate the translation of LacZ in the presence of a cell-free system comprising components for the translation. LacZ is known in the art to cleave the yellow chlorophenol Red-β-D-galactopyranoside (CPRG) substrate to produce the purple chlorophenol red product. Because the RNA sensor also comprises the yellow chlorophenol Red-β-D-galactopyranoside (CPRG) substrate, a color change from yellow to purple can indicate the detection of the RNA. In another example of an RNA sensor, chitinase can be used as an alternative colorimetric reporter enzyme, which cleaves the colorless 4-Nitrophenyl N,N′-diacetyl-beta-D-chitobioside substrate to a yellow p-nitrophenol product.

RNA sensors can be used to detect RNAs of interest in a sample, and optionally quantitate the RNA level. RNAs of interest include, but are not limited to, antibiotic resistance genes, and mRNAs that encode proteins of interest.

In one embodiment, the reaction regions of the porous matrix host the same sensors, and thus a plurality of samples can be tested for the same analyte using the electronic readers disclosed herein.

In one embodiment, the reaction regions host different sensors, and thus a plurality of analytes can be detected on the same support or substrate using the electronic readers disclosed herein.

In one embodiment, the same reaction region can host one or more different sensors.

The analyte can be a gas molecule, a nucleic acid, a protein, a peptide, a pathogen, a pathogen extract, a metabolite, an antibiotic drug, an explosive chemical, a toxic chemical, or an industrial chemical. An industrial chemical can be a process by-product such as cellobiose, an intermediate in fuel production, or a bioreactor product such as vitamins. The analyte can be a solid, liquid or gas. In one embodiment, the analyte is a heavy metal. In one embodiment, the analyte is an insecticide residue. The analyte can be from a variety of samples, including, but not limited to, a biological sample, an environmental sample, a culture sample, an industry sample (e.g., biofuel production).

In some embodiments, the synthetic gene network comprises a logic circuit, and thus can perform one or more logic functions upon activation. In the field of synthetic biology, significant progress has been made in designing and assembling biological components into logic circuits that can mimic or even outperform electronic circuits, resulting in the creation of a large variety of logic circuits. See WO2014093852 for examples.

In one embodiment, the logic circuit can be activated by contacting the logic circuit with water.

In one embodiment, the logic circuit can be activated by contacting the logic circuit with water and a composition comprising one or more triggers. By way of examples only, an AND gate is one of the most basic logic circuits, requiring the simultaneous presence of two appropriate triggers in order for the AND gate to turn on. If only one of the triggers is present, the AND gate would not turn on.

The trigger can comprise temperature, pressure, humidity, light intensity, light spectrum, an electrical current, a voltage, a chemical element, an ion, a small molecule, a peptide, a protein, a nucleic acid, an extract, or a combination thereof.

In one embodiment, signal produced by a sensor described herein can serve as a component in a logic circuit.

In one embodiment, proteins lyophilized into the reaction regions or proteins expressed by a template-directed synthetic reaction can form a logic function or a portion thereof.

In one embodiment, the sample comprises other types of synthetic biological circuits, such as those substantially free of template nucleic acids, e.g., an engineered signaling pathway. A solution comprising a kinase can be used to activate the pathway and amplify input. There are two main types of engineered signaling pathway: those that rewire existing signal transduction pathways, and those that create artificial signaling modules. More details about engineered signaling pathways can be found, for example, in Kiel et al., Cell 2010, 140, 33-47, and Grubelnik et al., Biophysical Chemistry 2009, 143, 132-138, the contents of each of which are incorporated herein by reference in their entirety.

The electronic readers disclosed herein can also be used to monitor/measure a chemical or biochemical reaction in a liquid sample. In one embodiment, the liquid sample comprises reactive components that are undergoing a chemical or biochemical reaction. In another embodiment, the liquid sample comprises a component that can react with one or more compounds on the porous matrix. In yet another embodiment, a second liquid sample is added to the porous matrix impregnated with the first liquid sample, where the first liquid sample comprises a component that can react with another component in the second liquid sample. Chemical or biochemical reactions applicable herein include any reaction which can produce a change in an optical signal, e.g., an increase in the intensity of the optical signal, a reduction in the intensity of the optical signal, or a change in the wavelength or polarization of the optical signal. Exemplary chemical or biochemical reactions include, but are not limited to, condensation, acylation, dimerization, alkylation, rearrangement, transposition, decarbonylation, coupling, aromatization, epoxidation, disproportionation, hydrogenation, oxidation, reduction, substitution, isomerization, stereoisomerization, functional group conversion, functional group addition, elimination, bond cleavage, photolysis, photodimerization, cyclization, hydrolysis, polymerization, binding, such as between a receptor and a ligand; inhibition, such as between an enzyme and an inhibitor; recognition, such as between an antibody and a hapten; activation, such as between an agonist and a receptor; inactivation, such as between an antagonist and a receptor; protein synthesis; enzyme-mediated reactions; interactions between biomolecules (including nucleic acids), and the like.

In one embodiment, the electronic readers disclosed herein can also be used for drug discovery using protein targets or whole cells, screens for protein function, in vitro engineering and assembly of metabolic pathways, and combinatorial chemistry. In some embodiments, biological cells can be grown on, within, or under the porous matrix.

In one embodiment, the optical measurement can be made periodically continuous over a period of time. The period of time can be on the order of seconds, minutes, or hours, depending upon the exact measurement. This can be particularly advantageous for monitoring reaction kinetics. In one embodiment, a reaction curve can be generated for accumulation of signal.

It should be noted that in all aspects of the technology described herein, the sample should be in a hydrated state when it is measured by the electronic reader described herein.

It should be understood that this invention is not limited to the particular methodology, protocols, and reagents, etc., disclosed herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities of ingredients or reaction conditions used herein should be understood as modified in all instances by the term “about.”

Although any known methods, devices, and materials may be used in the practice or testing of the invention, the methods, devices, and materials in this regard are disclosed herein.

Some embodiments of the invention are listed in the following numbered paragraphs:

paragraph 1. An electronic reader for performing an optical measurement on a sample present on a porous matrix, wherein the reader comprises a light source, a cassette that supports the porous matrix, and a detecting module, and wherein the cassette is configured to be detachable.
paragraph 2. The electronic reader of paragraph 1, wherein the cassette is disposed between the light source and the detecting module when the reader is in use.
paragraph 3. The electronic reader of paragraph 1, wherein the light source and the detecting module are on the same side of the cassette.
paragraph 4. The electronic reader of any one of paragraphs 1-3, wherein the reader is portable.
paragraph 5. The electronic reader of any one of paragraphs 1-4, further comprising a housing, wherein the housing encloses the light source, cassette, and detecting module.
paragraph 6. The electronic reader of any one of paragraphs 1-5, further comprising a printed circuit board.
paragraph 7. The electronic reader of any one of paragraphs 1-6, wherein the light source comprises an array of light-emitting diodes.
paragraph 8. The electronic reader of any one of paragraphs 1-6, wherein the light source comprises a laser.
paragraph 9. The electronic reader of any one of paragraphs 1-6, wherein the light source is diffuse.
paragraph 10. The electronic reader of any one of paragraphs 1-9, wherein the detecting module comprises an array of photodiodes.
paragraph 11. The electronic reader of any one of paragraphs 1-9, wherein the detecting module comprises a luminosity sensor.
paragraph 12. The electronic reader of any one of paragraphs 1-9, wherein the detecting module comprises a sensor configured to collect an image.
paragraph 13. The electronic reader of paragraph 12, wherein the detecting module comprises a charge-coupled device (CCD) or complementary metal oxide semiconductor sensor (CMOS sensor).
paragraph 14. The electronic reader of any one of paragraphs 1-13, wherein the cassette comprises an array of apertures, and wherein when the reader is in use, light transmitted through the array of apertures is detected by the detecting module.
paragraph 15. The electronic reader of any one of paragraphs 1-14, wherein the optical measurement is absorbance measurement.
paragraph 16. The electronic reader of any one of paragraphs 1-14, wherein the optical measurement is fluorescence measurement.
paragraph 17. The electronic reader of any one of paragraphs 1-14, wherein the optical measurement is colorimetric measurement.
paragraph 18. The electronic reader of any one of paragraphs 1-14, wherein the optical measurement is luminescence measurement.
paragraph 19. The electronic reader of any one of paragraphs 1-18, wherein the reader can relay a signal to a computing device.
paragraph 20. A measurement system comprising an electronic reader of any one of paragraphs 1-19 and at least one sample comprising a synthetic biological circuit on a porous matrix.
paragraph 21. The measurement system of paragraph 20, wherein the sample is lyophilized or frozen.
paragraph 22. The measurement system of paragraph 20 or 21, wherein the porous matrix comprises paper, quartz microfiber, mixed esters of cellulose, porous aluminum oxide, or a patterned surface.
paragraph 23. The measurement system of paragraph 22, wherein the porous matrix is a sheet of paper comprising wax patterns.
paragraph 24. The measurement system of any one of paragraphs 20-23, wherein the synthetic biological circuit is a synthetic gene network or an engineered signaling pathway.
paragraph 25. The measurement system of paragraph 24, wherein the synthetic gene network is a nucleic-acid-based sensor.
paragraph 26. The measurement system of any one of paragraphs 20-25, wherein a plurality of samples is distributed at measurement sites on the porous matrix, and wherein the plurality of samples is aligned with the array of apertures in the cassette.
paragraph 27. The measurement system of any one of paragraphs 20-26, wherein the porous matrix comprises an identification tag.
paragraph 28. A measurement system comprising an electronic reader of any one of paragraphs 1-19 and at least one sample comprising a cell-free system on a porous matrix.
paragraph 29. The measurement system of paragraph 28, wherein the sample is lyophilized or frozen.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow. Further, to the extent not already indicated, it will be understood by those of ordinary skill in the art that any one of the various embodiments herein described and illustrated can be further modified to incorporate features shown in any of the other embodiments disclosed herein.

All patents and other publications; including literature references, issued patents, published patent applications, and co-pending patent applications; cited throughout this application are expressly incorporated herein by reference for the purpose of describing and disclosing, for example, the methodologies described in such publications that might be used in connection with the technology disclosed herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

The description of embodiments of the disclosure is not intended to be exhaustive or to limit the disclosure to the precise form disclosed. While specific embodiments of, and examples for, the disclosure are disclosed herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments disclosed herein can be combined to provide further embodiments. Aspects of the disclosure can be modified, if necessary, to employ the compositions, functions and concepts of the above references and application to provide yet further embodiments of the disclosure.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

### EXAMPLES

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The technology disclosed herein is further illustrated by the following examples which in no way should be construed as being further limiting.

### Example 1

### Arduino Sketch for Three-Reaction Electronic Reader

Following is a series of codes for a three-reaction electronic reader:

#include <Wire.h>
#include <Adafruit_Sensor.h>
#include <Adafruit_TSL2561.h>
Adafruit_TSL2561 tsl1 = Adafruit_TSL2561(TSL2561_ADDR_HIGH, 00001);
Adafruit_TSL2561 tsl2 = Adafruit_TSL2561(TSL2561_ADDR_FLOAT, 00002);
Adafruit_TSL2561 tsl3 = Adafruit_TSL2561(TSL2561_ADDR_LOW, 00003);
uint16_t broadband = 0;
uint16_t infrared = 0;
int led1 = 13;
int led2 = 12;
int led3 = 11;
unsigned int tsl1current =0;
unsigned int tsl2current =0;
unsigned int tsl3current =0;
unsigned int tsl1max = 0;
unsigned int tsl2max = 0;
unsigned int tsl3max = 0;
float tsl1val =0;
float tsl2val =0;
float tsl3val =0;
void configureSensor(void)
{

```
  tsl1.setGain(TSL2561_GAIN_16X); /* 16x gain ... use in low light to boost sensitivity */
  tsl1.setIntegrationTime(TSL2561_INTEGRATIONTIME_402MS); /* 16-bit data but
```

slowest conversions */

```
  tsl2.setGain(TSL2561_GAIN_16X); /* 16x gain ... use in low light to boost sensitivity */
  tsl2.setIntegrationTime(TSL2561_INTEGRATIONTIME_402MS); /* 16-bit data but
```

slowest conversions */

```
  tsl3.setGain(TSL2561_GAIN_16X); /* 16x gain ... use in low light to boost sensitivity */
  tsl3.setIntegrationTime(TSL2561_INTEGRATIONTIME_402MS); /* 16-bit data but
```

slowest conversions */
}
void setup(void)
{

pinMode(led1, OUTPUT);
pinMode(led2, OUTPUT);
pinMode(led3, OUTPUT);
Serial.begin(9600);
configureSensor( ); /* Setup the sensor gain and integration time */

}
void loop(void)
{

sensors_event_t event;
digitalWrite(led1, HIGH);
tsl1.getEvent(&event); // Get a new sensor event
tsl1.getLuminosity (&broadband, &infrared); // Populate broadband with the latest values
tsl1current=broadband;
Serial.print(broadband);
Serial.print(“, ”);
digitalWrite(led1, LOW);
if (broadband > tsl1max)

{ tsl1max=broadband;
}

digitalWrite(led2, HIGH);
tsl2.getEvent(&event); // Get a new sensor event
tsl2.getLuminosity (&broadband, &infrared); // Populate broadband with the latest values
tsl2current=broadband;
Serial.print(broadband);
Serial.print(“, ”);
digitalWrite(led2, LOW);
if (broadband > tsl2max)

{ tsl2max=broadband;
}

digitalWrite(led3, HIGH);
tsl3.getEvent(&event); // Get a new sensor event
tsl3.getLuminosity (&broadband, &infrared); // Populate broadband infrared with the latest

values

tsl3current=broadband;
Serial.print(broadband);
digitalWrite(led3, LOW);
if (broadband > tsl3max)

{ tsl3max=broadband;
}

Serial.print(“ ”);
tsl1val=(float)tsl1current/(float)tsl1max;
tsl1val=100*tsl1val;
tsl1val=100−tsl1val;
Serial.print(tsl1val);
Serial.print(“, ”);
tsl2val=(float)tsl2current/(float)tsl2max;
tsl2val=100*tsl2val;
tsl2val=100−tsl2val;
Serial.print(tsl2val);
Serial.print(“, ”);
tsl3val=(float)tsl3current/(float)tsl3max;
tsl3val=100*tsl3val;
tsl3val=100−tsl3val;
Serial.println(tsl3val);
delay(2500-2433); //delay time in milliseconds - 2433ms(time for the 3 sensors readout and

calculations)
}

### Example 2

### Arduino Sketch for Twelve-Reaction Electronic Reader

1. An electronic reader for performing an optical measurement on a sample present on a porous matrix, wherein the reader comprises a light source, a cassette that supports the porous matrix, and a detecting module, and wherein the cassette is configured to be detachable.

2. The electronic reader of claim 1, wherein the cassette is disposed between the light source and the detecting module when the reader is in use.

3. The electronic reader of claim 1, wherein the light source and the detecting module are on the same side of the cassette.

4. The electronic reader of claim 1, wherein the reader is portable.

5. The electronic reader of claim 1, further comprising a housing, wherein the housing encloses the light source, cassette, and detecting module.

6. The electronic reader of claim 1, further comprising a printed circuit board.

7. The electronic reader of claim 1, wherein the light source comprises an array of light-emitting diodes or a laser.

8.-9. (canceled)

10. The electronic reader of claim 1, wherein the detecting module comprises an array of photodiodes or a luminosity sensor or a sensor configured to collect an image.

11.-12. (canceled)

13. The electronic reader of claim 1, wherein the detecting module comprises a charge-coupled device (CCD) or complementary metal oxide semiconductor sensor (CMOS sensor).

14. The electronic reader of claim 1, wherein the cassette comprises an array of apertures, and wherein when the reader is in use, light transmitted through the array of apertures is detected by the detecting module.

15. The electronic reader of claim 1, wherein the optical measurement is absorbance measurement, fluorescence measurement, colorimetric measurement or luminescence measurement.

16.-18. (canceled)

19. The electronic reader of claim 1, wherein the reader can relay a signal to a computing device.

20. A measurement system comprising an electronic reader of claim 1 and at least one sample comprising a synthetic biological circuit on a porous matrix.

21. The measurement system of claim 20, wherein the sample is lyophilized or frozen.

22. The measurement system of claim 20, wherein the porous matrix comprises paper, quartz microfiber, mixed esters of cellulose, porous aluminum oxide, or a patterned surface.

23. The measurement system of claim 20, wherein the porous matrix is a sheet of paper comprising wax patterns.

24. The measurement system of claim 20, wherein the synthetic biological circuit is a synthetic gene network or an engineered signaling pathway.

25. The measurement system of claim 20, wherein the synthetic gene network is a nucleic-acid-based sensor.

26. (canceled)

27. The measurement system of claim 20, wherein the porous matrix comprises an identification tag.

28. A measurement system comprising an electronic reader of claim 1 and at least one sample comprising a cell-free system on a porous matrix.

29. (canceled)
